(19) United States
(12) Patent Application Publication
(10) Pub. No.: US 2025/0028550 A1
(43) Pub. Date: Jan. 23, 2025

(54) HIDING SENSITIVE INFORMATION IN COLLABORATIVE VIRTUAL DESKTOP SESSIONS

(71) Applicant: Omnissa, LLC, Mountain View, CA (US)

(72) Inventors: Yunxia Cheng, Beijing (CN); Lin Lv, Beijing (CN); Guoxin Liu, Beijing (CN); Peiwei Huang, Beijing (CN); Qian Liu, Beijing (CN); Jian Song, Beijing (CN)

(21) Appl. No.: 18/465,689

(22) Filed: Sep. 12, 2023

(30) Foreign Application Priority Data
Jul. 18, 2023 (WO) PCT/CN2023/107864

(51) Int. Cl. G06F 9/455

(52) U.S. Cl. CPC G06F 9/45558; G06F 2009/45575

(57) ABSTRACT

Systems and methods are described for hiding a primary user's sensitive information in collaborative virtual desktop sessions where multiple secondary users access the primary user's virtual desktop. In particular, embodiments described herein leverage a mechanism for monitoring when designated sensitive applications are opened in the virtual desktop. After the primary user sets up a collaborative session on their virtual desktop, if a sensitive application opens in the virtual desktop during the collaborative session, the sharing of the desktop graphical user interface (GUI) can be stopped and the user can be prompted (e.g., via a warning dialog that pops up) to choose how to proceed. For example, the user can choose to hide the entire desktop, to minimize or close the sensitive application, or to continue sharing the desktop but pop-out the sensitive application from the remote desktop in a separate window that is not shared with the collaborators.

### CLAIM OF PRIORITY

This application is based upon and claims the benefit of priority from International Patent Application No. PCT/CN2023/107864, filed on Jul. 18, 2023, which is incorporated by reference herein in its entirety.

### TECHNICAL FIELD

The present disclosure generally relates to virtual desktop infrastructure and more specifically to techniques for allowing multiple users to collaboratively access a virtual desktop with separate remote client devices.

### BACKGROUND OF THE INVENTION

Virtual desktops provided as part of a virtual desktop infrastructure (VDI) or desktop-as-a-service (DAAS) offerings are becoming more commonplace in today's enterprise work environments. The security of having a remotely stored desktop, ability to access the desktop from any location and on any device, centralized desktop management, efficient use of hardware resources, as well as numerous other benefits made possible by VDI/DAAS are a large benefit for many organizations.

In a conventional VDI or DAAS environment, each user in an enterprise is provisioned a virtual desktop and is allowed to access his or her virtual desktop over a remote network connection, such as a WAN connection. The virtual desktops are typically hosted on servers that reside in a data center of the enterprise or a third-party service provider, and each host server may execute multiple virtual desktops. Users can utilize a client device to remotely log into their individual virtual desktop and all of the application execution takes place on the remote host server which is linked to the local client device over a network using a remote display protocol, such as Remote Desktop Protocol (RDP), PC-over-IP protocol (PCoIP), virtual network computing (VNC) protocol, or the like. Using the remote display protocol, the user can interact with applications of the virtual desktop, which are running on the remote host server, with only the display, keyboard, and mouse information communicated with the local client device. A common implementation of this approach is to host multiple desktop operating system instances on separate virtual machines deployed on a server hardware platform running a hypervisor.

The virtual desktop session collaboration feature enables multiple users to collaborate on a single virtual desktop. This feature allows a primary user of a virtual desktop to share their virtual desktop with secondary users using their own virtual desktop clients without the need for third-party collaboration software. With the session collaboration feature, after the primary user logs into their remote desktop, the primary user can send invitations providing session links to other secondary users (via instant message, e-mail, etc.). Using the link, the secondary users can connect to the virtual desktop's agent using their own virtual desktop clients and log in with their authentication information. Once the secondary users are connected, all users can collaborate on the desktop with each user being able to view the desktop's graphical user interface (GUI) and optionally provide inputs into the desktop using their respective clients. Generally, the primary user can control which user is able to provide inputs into the desktop via a collaboration user interface.

While virtual desktop session collaboration offers many benefits such as convenience, efficiency, and eliminating the need for third-party conferencing software, it also presents challenges. For example, during a collaboration session, the primary user shares their entire desktop with secondary users. However, some content from specific applications may be sensitive and the primary user may not wish to share it with others, such as the contents of emails, messages from instant message applications, etc. In some cases, such sensitive information simply pops up without warning and can be seen by every secondary user in the collaborative session. Such unintentional exposure of sensitive information can cause significant security and privacy problems.

What is needed is a more efficient way for hiding sensitive information in collaborative virtual desktop sessions.

### BRIEF DESCRIPTION OF DRAWINGS

FIG. 1 illustrates an example of a virtual desktop environment, in accordance with various embodiments.

FIG. 2 illustrates an example diagram of a system for providing collaborative access to a virtual desktop, in accordance with various embodiments.

FIG. 3 illustrates an example of components in a system for hiding sensitive information in collaborative virtual desktop sessions, in accordance with various embodiments.

FIG. 4 illustrates an example swim lane diagram of a process for hiding sensitive information in collaborative virtual desktop sessions, in accordance with various embodiments.

FIG. 5 illustrates an example of some general components of a computing device, in accordance with various embodiments.

### DETAILED DESCRIPTION OF THE INVENTION

Systems and methods in accordance with various embodiments of the present disclosure overcome at least some of the above-mentioned shortcomings and deficiencies by providing efficient ways for hiding sensitive information in collaborative virtual desktop sessions. In particular, embodiments described herein leverage a mechanism for monitoring when certain applications that are designated “sensitive” (which may be applications such as email and message applications) are opened in the virtual desktop. In various embodiments, the virtual desktop owner (or primary user) can designate the sensitive applications. After the primary user sets up a collaborative session on their virtual desktop, if a sensitive application opens in the virtual desktop during the collaborative session, the sharing of the desktop graphical user interface (GUI) can be stopped and the user can be prompted (e.g., via a warning dialog that pops up) to choose how to proceed. For example, the user can choose to hide the entire desktop, to minimize or close the sensitive application, or to continue sharing the desktop but pop-out the sensitive application from the remote desktop in a separate window that is not shared with the collaborators. Further, if a sensitive application is open in the virtual desktop when the primary user attempts to start a collaborative session, the primary user can be similarly prompted with a warning dialog to notify them that a sensitive application is open and to provide the primary user with similar options before proceeding to sharing the desktop with secondary users.

As used throughout this disclosure in the context of remote desktop environments, the terms, “desktop”, “remote desktop”, and “virtual desktop” are used interchangeably and refer to an instance of an operating system and/or applications that run(s) remotely with respect to the user. In a conventional VDI or DAAS environment, each virtual desktop corresponds to a virtual machine (VM) executed on a host server (i.e., a host computing device) that is physically located in a remote datacenter. Each host server may host any number of virtual machines (e.g., tens, hundreds, etc.) and each virtual machine may be owned by an individual user. The virtual machine typically includes a guest operating system (e.g., Windows) capable of executing applications for the user and the virtual machine is used to provide a virtual desktop for the individual user. The user who owns the virtual desktop can remotely log into his or her virtual desktop using a client device that establishes a network connection (e.g., Wide Area Network connection) with the host server and remotely execute various applications on the virtual machine as if the desktop was running on the user's local client device. The client device can be any computing device capable of establishing a network connection, including but not limited to personal computers (PCs), laptops, mobile phones, tablet computers, wearable devices (e.g., smart watches, electronic smart glasses, etc.) or the like.

When a client device is accessing a remote desktop using a remote display protocol (e.g., RDP, PCoIP, VNC, etc.), the graphical user interface (GUI) of the desktop is generated on the server, the GUI image data is then encoded and transmitted over the network to the client device, where it is decoded and displayed to the user. For example, in one embodiment, the framebuffer pixel data on the server is encoded using a codec, such as H264, and transmitted over an Internet connection to the client, where the data is decoded and rendered on a local display screen to the user. Similarly, any user input information, such as keyboard and mouse events, is transmitted from the client device to the server over the network connection, where it may in turn cause various updates to the GUI of the remote desktop. In this manner, the user is able to view the GUI of the remote desktop and interact with it as if the desktop was actually running on the local client device, even though the desktop is actually executing remotely.

In some cases, instead of providing a user with access to a full desktop session, i.e., where the user gets to see and interact with substantially the entire remote computing environment (e.g., the entire operating system, all applications, settings, etc., of the remote virtual machine), the user can be given access to a limited portion of the desktop or to a certain application or applications on the desktop, so that the user is able to see and interact with the limited portion or certain application(s) and not with other parts of the virtual desktop, which can be hidden from the user. This approach is preferable, for example, when an enterprise wishes to deliver access to a particular application to users, without giving access to the remainder of the computing environment where the application runs. This type of session may be referred to as a “virtual application”, “remote application”, or an “application session” throughout this disclosure and these terms may be used interchangeably. Hence, with a virtual application, the application can run inside a remote desktop but look and feel to the user on his or her client device as if only the application is executing. Behind the scenes, however, the application can be running inside a desktop session, but only the application's user interface (UI) may be visible and accessible to the user on the client device. As in a full desktop session, with virtual applications user inputs can be conveyed from the client device to the remote desktop and redirected to the operating system (OS) of the remote desktop, so that the OS can deliver the inputs to the application, while the GUI of the application is streamed back and displayed on the client device.

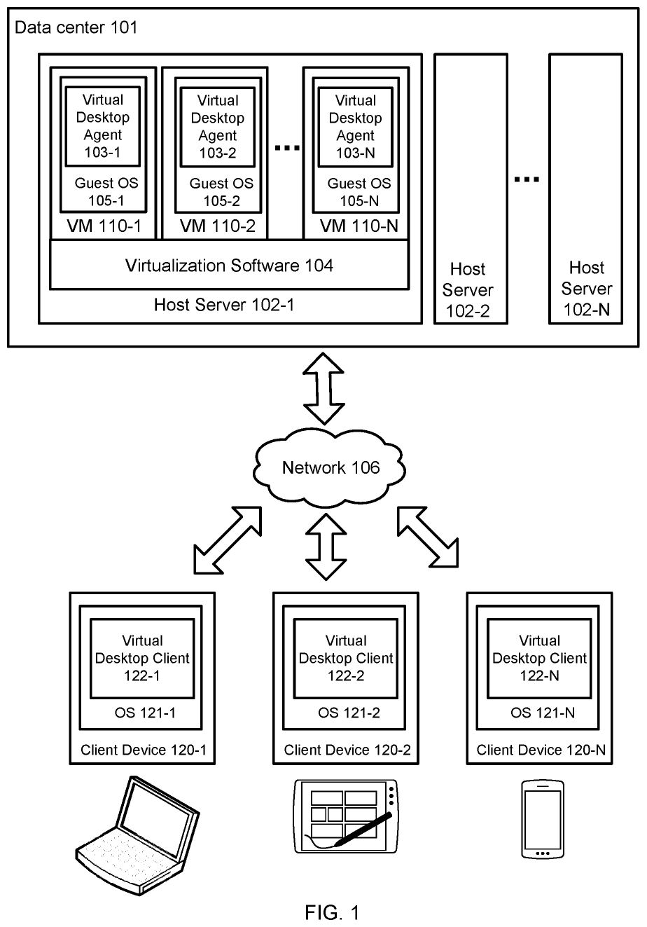

FIG. 1 illustrates an example of a virtual desktop environment, in accordance with various embodiments. The virtual desktop environment, such as VDI or DAAS environment, includes host servers (102-1, 102-2, 102-N) that are communicatively coupled with a number of client devices (120-1, 120-2, 120-N) via a network 106. Network 106 may be a wide area network (WAN), or other form of remote communication link between the host servers (102-1, 102-2, 102-N) and client devices (120-1, 120-2, 120-N). Network 106 may further include numerous other components, such as one or more firewalls, connection brokers, management servers, etc., which are not shown here so as not to obscure salient features of the remote desktop environment. Host servers (102-1, 102-2, 102-N) may physically reside in a data center 101 of the enterprise (e.g., in case of VDI) or in a data center of a third party service provider (e.g., in case of DAAS).

By way of illustration, host server 102-1 can interoperate with client devices (120-1, 120-2, 120-N) to provide virtual desktop services to users of client devices (120-1, 120-2, 120-N). For example, host server 102-1 can host, for each user, a desktop that is presented by a guest operating system (such as one of the guest operating systems 105-1, 105-2, 105-N) running on a virtual machine (such as one of the virtual machines 110-1, 110-2, 110-N) on host server 102-1. In this context, the terms “desktop”, “remote desktop”, and “virtual desktop” refer to a computing environment in which a user can launch, interact with, and manage the user's applications, settings, and data. Each client device (120-1, 120-2, 120-N) can allow a user to view on a desktop graphical user interface (on a local display device) his/her desktop that is running remotely on host server 102-1, as well as provide commands for controlling the desktop. In this manner, the users of client devices (e.g., 120-1, 120-2, 120-N) can interact with the desktops hosted on host server 102-1 as if the desktops were executing locally on client devices (120-1, 120-2, 120-N).

In the embodiment of FIG. 1, host server 102-1 includes virtualization software 104 that supports the execution of one or more virtual machines (VMs) (e.g., 110-1, 110-2, 110-N). The virtualization software 104 may be a hypervisor, a virtual machine manager (VMM) or other software that allows multiple virtual machines to share the physical resources of the server. In the illustrated embodiment, each virtual machine (e.g., 110-1, 110-2, 110-N) can execute a guest operating system (e.g., 105-1, 105-2, 105-N) that hosts a desktop for a single user at a time. For example, if five users connect to host server 102-1 for the purpose of initiating remote desktop sessions, the host server 102-1 can launch five VMs, each hosting one desktop for each one of the five users. These types of virtual desktop environments where user desktops are hosted within separate, server-side virtual machines are often referred to as virtual desktop infrastructure (VDI) or Desktop-as-a-Service (DAAS) environments.

In such virtual desktop environments, each client device (e.g., 120-1, 120-2, 120-N) can execute a virtual desktop client (e.g., 122-1, 122-2, 122-N). For example, the virtual desktop client (e.g., 122-1, 122-2, 122-N) can be a stand-alone, designated client application (“native client”), or a web browser (“web client”). In some cases, a standard web browser may be modified with a plugin to operate as a web client. The interaction between the virtual desktop and the client device can be facilitated by such a virtual desktop client (e.g., 122-1, 122-2, 122-N) running in the OS (e.g., 121-1, 121-2, 121-N) on the client device (e.g., 120-1, 120-2, 120-N) which communicates with a server-side virtual desktop agent (e.g., 103-1, 103-2, 103-N) that is running on the guest OS inside the virtual machine (e.g., 110-1, 110-2, 110-N). In particular, the interaction can be performed by the virtual desktop agent transmitting encoded visual display information (e.g., framebuffer data) over the network to the virtual desktop client and the virtual desktop client in turn transmitting user input events (e.g., keyboard, mouse events) to the remote desktop agent. Interactions between the virtual desktop client (e.g., 122-1, 122-2, 122-N) and the virtual desktop agent (e.g., 103-1, 103-2, 103-N), including transmission of encoded visual display information from the agent to the client and user input events from the client to the agent can be performed using a remote desktop protocol, such as Remote Desktop Protocol (RDP), PC-over-IP protocol (PCoIP), VMware Blast, virtual network computing (VNC) protocol, or the like.

It should be noted that the particular virtual desktop environment illustrated in FIG. 1 is shown purely for purposes of illustration and is not intended to be in any way inclusive or limiting to the embodiments that are described herein. For example, a typical enterprise VDI deployment would include many more host servers, which may be distributed over multiple data centers, which might include many other types of devices, such as switches, power supplies, cooling systems, environmental controls, and the like, which are not illustrated herein. Similarly, a single host server would typically host many more virtual machines than what is shown in this illustration. It will be apparent to one of ordinary skill in the art that the example shown in FIG. 1, as well as all other figures in this disclosure have been simplified for ease of understanding and are not intended to be exhaustive or limiting to the scope of the invention.

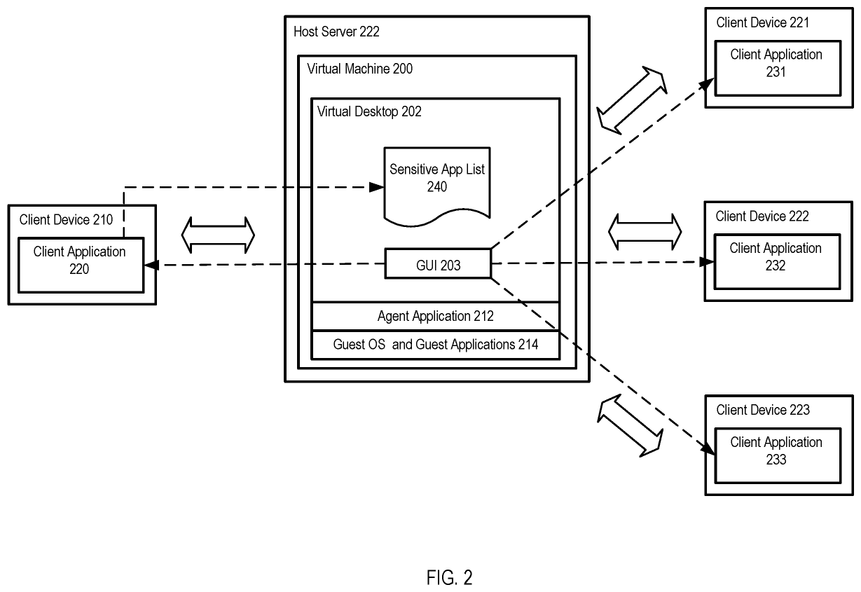

FIG. 2 illustrates an example diagram of a system for providing collaborative access to a virtual desktop, in accordance with various embodiments. As illustrated, a client device 210 can be communicatively linked, e.g., over a network such as the Internet or a local area network (LAN), to a virtual machine 200 residing on a host server 222, which may reside inside an on-premises datacenter or a datacenter of a third-party service provider. A guest operating system (OS) and guest applications 214 may be executing in the VM 200 to produce a virtual desktop 202. A primary user or “owner” can interact with the virtual desktop 202 on the client device 210 via a client application 220 (a virtual desktop client), which may be a native client application (such as the VMware Horizon Client Application, available from VMware, Inc.), running on the client device 210 that communicates with an agent application 212 (a virtual desktop agent) in the virtual machine 200. The host server 222 can authenticate users and take requests for desktop sessions, orchestrating a secure direct protocol connection from the client 220 to the agent 212.

The primary user's inputs, such as keyboard and mouse inputs, produced in the client application 220 can be transmitted by the client application 220 to the agent 212 based on a remoting protocol, and the agent can inject the inputs into the virtual desktop 202 to effectuate them. Outputs of the virtual desktop 202, such as the GUI 203 of the virtual desktop 202, can be transmitted by the agent 212 to the client device 210 (as illustrated by the broken arrow from the GUI 203 to the client 220) based on the remoting protocol and displayed in the client application 220. Other outputs, such as audio, can likewise be conveyed to the client 220. In this way, the primary user on the client device 210 may be able to interact with the virtual desktop 202 as if it was executing locally on the client device 210 while execution actually takes place in the remote VM 200.

In various embodiments, the primary user or “owner” of the virtual desktop 202 can initiate a virtual desktop 202 session by executing the client application 220 and authenticating themself with the server 222 (e.g., by providing a login ID and a password). The desktop session can be established and the primary owner's client 220 can be connected to the virtual desktop 202, as indicated by the double-sided arrow between the desktop 202 and client 220. For example, the connection between the client 220 and the virtual desktop 202 can be a remoting protocol session.

Consequently, other “secondary” users can be invited to connect to the virtual desktop as collaborators. For example, the primary user can invite secondary users by sending an invitation (e.g., via email, instant message, etc.) containing a link to the virtual desktop 202 to each users' client devices (e.g., 221, 222, 223). The link can comprise information for routing to the virtual desktop 202, such as the desktop's 202 address on the local network or on a WAN (such as a URL). The collaborators' client devices 221, 222, 223 can be any client devices that are communicatively linked over a network to the server 222. For example, the collaborator devices 221, 222, 223 may be located on the local enterprise network or they may be located more remotely and connected over the Internet.

The primary user can prompt the system (e.g., via the agent 212) to send an invitation to a set of identified users via an option in a UI in the client 220. The system (e.g., the agent 212) can send the invitation to each client device 221, 222, 223 in response to the received instruction from the client 220 to initiate the collaborative session with the secondary users. In other embodiments, invitations can be sent to the collaborator devices 221, 222, 223 in other ways, e.g., from the client device 210.

Once a collaborator client device 221, 222, 223 receives the invitation, the user of the client device 221, 222, 223 may accept the invitation, e.g., by clicking on the link in the email, IM, etc. When the collaborator accepts the invitation or clicks on the link, the client device 221, 222, 223 can automatically launch a virtual desktop client application 231, 232, 233 and connect to the virtual desktop via the supplied link. Because client applications such as 231, 232, 233 may be usable for purposes other than collaborative virtual desktop access, such as for accessing the collaborators' own virtual desktops (not pictured), the applications 231, 232, 233 may have already been installed on the collaborator client devices 221, 222, 223. In some embodiments, when a client device (e.g., 221, 222, 223) that does not have a virtual desktop client application installed receives an invitation, the client device can automatically download and install the client application (e.g., after prompting and receiving approval from the user) and the installed client can then proceed with establishing a connection with the virtual desktop 202. Also, each invitation message can contain a download link for the virtual desktop client application, which the invitee can select to launch a download of the client application if he or she does not have a client installed.

Once a collaborator's client 231, 232, 233 is launched and routed to the virtual desktop 202, prior to allowing connection, the host server 222 can authenticate each collaborator (e.g., by requesting a username and password, fingerprint, or however else authentication may be set up). In various embodiments, the same mechanisms can be used for connecting collaborators to the shared desktop as implemented in standard virtual desktop connections between a client and a virtual desktop (i.e., without collaboration). For example, the connection between each collaborator's client 231, 232, 233 and the virtual desktop 202 can be a separate remoting protocol session, while the owner's client 220 can also be connected to the virtual desktop 202 via its own separate remote desktop protocol session.

To clarify, as used herein in various embodiments, the terms “virtual desktop session” or “desktop session” refer to a running instance of the virtual desktop (e.g., 202) in the virtual machine 200 (e.g., a Windows session). Each client (e.g., 220, 231, 232, 233) can connect to the virtual desktop (e.g., 202) via a separate remoting protocol session. Hence, during collaboration, clients (e.g., 220, 231, 232, 233) can share or connect to the same virtual desktop session, each via its own unique connection or remoting protocol session.

After the collaborative clients 231, 232, 233 are authorized by the server, a connection can be established between each client 231, 232, 233 and the virtual desktop 202, as indicated by the double-sided arrows pointing to the client devices 231, 232, 233. The GUI 203 of the virtual desktop can be streamed to each client 231, 232, 233 via the corresponding connection.

As a result, each collaborative client 231, 232, 233 may display the GUI 203 of the virtual desktop 202 so the participants of the collaborative session are able to view the GUI 203 on their devices 221, 222, 223. Further, to enable active collaboration, various techniques can be implemented to allow the owner as well as each invited secondary user to produce inputs in the desktop 202, such as mouse and keyboard inputs. For example, input control can be shared among the users, such that inputs from more than one of the clients 220, 231, 332, 233 are allowed into the virtual desktop 202 at the same time. In other embodiments, input control can be passed around (e.g., it can be assigned or delegated by the primary user to any of the secondary users), such that inputs from only one of the clients 220, 231, 332, 233 are allowed into the virtual desktop 202 at any given time.

In various embodiments, the primary user can be given authority to select (via a dashboard UI) which user or users have input control at any given time. The owner may be able to grant or take back such control at any point. In other embodiments, a collaborator may be able to request input control and receive control when the owner consents.

The system can control which clients (e.g., 220, 231, 332, 233) are permitted to produce inputs in the desktop 202 in a variety of ways. In an embodiment, the agent 212 can receive inputs from each collaborator's client (as well as from the owner's client) and decide which input to process. If the desktop session owner gives input control to a collaborator, the agent 212 can process the input from that specific collaborator while ignoring inputs from others (including the session owner).

For example, each client 220, 231, 332, 233 may be permitted to convey inputs to the virtual desktop 202 in the same way as in a standard, non-collaborative VDI session (i.e., each client 220, 231, 332, 233 may behave as if it has input control); however, the agent 212 can mute inputs from clients 220, 231, 332, 233 that it is instructed do not have input control, and permit inputs from clients that it is instructed do have input control. In this way, a standard VDI connection can be implemented between the virtual desktop 202 and each client 220, 231, 332, 233 (i.e., with screen data flowing to the clients 220, 231, 332, 233 from the desktop 202 and inputs flowing in the opposite direction from the clients 220, 231, 332, 233 to the desktop 202) while the agent 212 selectively determines which clients' 220, 231, 332, 233 inputs to mute and which clients' 220, 231, 332, 233 inputs to permit. In addition, the owner can have the option to shut down the connection with either collaborative client (e.g., 231, 232, 233) to kick them off, to cancel the collaboration and shut down all the collaborative connections but not the owner's connection, or to simply terminate all connections with the desktop 202, such as by simply logging off.

In various embodiments, the system can utilize a sensitive application list 240 for monitoring when certain applications that have been designated as “sensitive” and are identified in the list 240 are opened in the virtual desktop 202 to protect contents of those applications from being seen by secondary users (e.g., users of client devices 221, 222, 223) during a collaborative session. The sensitive applications may be designated by the primary user or by administrators. For example, the primary user may be able to designate applications that they consider sensitive via the UI of the client 220 (e.g., in the settings of the virtual desktop client 220). In the client 220 settings, the primary user can be provided with a standard list of selectable applications so that they can select which of the applications in the standard list the primary user considers sensitive and wants to be hidden from collaborators. For example, administrators may put together a standard list, which can include any applications that potentially contain sensitive information, such as email client applications, instant message applications, etc. The primary user can be instructed to select applications from the standard list whose content the primary user wishes to hide during collaborative sessions. For example, an instruction can be presented to the primary user with the message: “Hide information from applications below in collaboration sessions” followed by a listing of selectable application names, and the primary user can select applications from the list that are to be treated as sensitive applications for collaborative sessions.

After the designated sensitive applications are determined, the client 220 can send the list 240 of sensitive applications to the virtual desktop (e.g., to the virtual desktop agent 212). In various embodiments, the client 220 can send the list 240 to the connection server brokering the client 220—agent 212 connection, and the connection server can send the list 240 to the agent 212. The client 220 can send the list 240 to the agent 212 every time it connects to the agent 212. When the primary user logs out, the client 220 can save the list of sensitive applications and it can send the list to the virtual desktop 202 next time the primary user logs into the desktop 202, or next time the client 220—agent 212 connection is established. The primary user can be permitted to change the list at any point (e.g., through the client 220 settings) and the updated list can be conveyed to the virtual desktop 202 whenever it is changed.

When the primary user initiates a collaborative session (e.g., when they invite a secondary user to join the desktop 202), before the desktop 202 is shared (e.g., before collaborators are added to the desktop 202 or before the GUI 203 is shared with any collaborators), the system can check whether any sensitive applications contained in the list 240 are open in the desktop 202. If a sensitive application is open in the desktop 202, a warning dialog can be presented to the user to notify them that a sensitive application is open, and the primary user can be provided with options on how to proceed regarding the open sensitive application. For example, a warning dialog can pop up notifying the user that a sensitive application is open and the user can be provided with several choices in the dialog on how to treat the sensitive application. The choices can be to minimize the application, close the application, pup-out the sensitive application from the remote desktop, stop sharing the desktop, or continue sharing the desktop (without hiding the application), as will be described in further detail below.

For example, if Application A (e.g., an email client) is included in the sensitive application list 240 and it is open when the user initiates a collaborative session, before sharing the desktop 202 with collaborators, a popup dialog can be presented to the user with a message such as “Application A is open, do you wish to hide it from collaborators?” and the user can be allowed to select any of various options on how to proceed as described above (close the application, minimize the application, pop-out the application, stop desktop sharing, or continue desktop sharing).

If the primary user chooses to minimize the application when they are prompted with the warning dialog, the sensitive application window can be minimized before proceeding with establishing the collaborative session (e.g., before sharing the desktop 202 with collaborators).

If the primary user chooses to close the application when they are prompted with the warning dialog, the sensitive application can be closed before proceeding with establishing the collaborative session (e.g., before sharing the desktop 202 with collaborators).

If the primary user chooses to pop-out the sensitive application from the remote desktop 202 when they are prompted with the warning dialog, the sensitive application can be closed in the desktop 202 and opened in a new window on the client device 210 that is not shared with collaborators. In various embodiments, to pop-out the sensitive application, the application can be closed in the desktop 202 and opened as a virtual application on the client device 210 in a new window. To perform this, the sensitive application can be launched on a remote server and remoted to the client device 210 so that the user can interact with the sensitive application on the client device 210 in the new window, which may be a second client 220 window, as if the application is executing locally on the client device while it is actually executing remotely.

For example, to open the sensitive application as a virtual application in a new window, the sensitive application can be launched in a different virtual machine (than VM 200) or different virtual desktop, which may run on a different server than the host server 222, and be presented in a different client 210 window (than the window where the desktop 202 GUI is presented) through which the user can access the sensitive application via a remoting protocol. The popped-out application can be launched as a seamless window to give the user the impression that the application is running on the client device 210, while it is running on a virtual machine. “Seamless window”, as used herein, refers to an application delivery method that allows remote applications to appear like local applications, giving users the illusion that the remote app is actually running locally (in this case, locally on the client device 210). For example, when the sensitive application is popped out from the remote desktop, to present it as a seamless window the guest operating system's background where the application is running can be cropped, masked, or blocked leaving just the interface of the application and the application interface can be presented in a new window of the client application 220 on the client device 210, which gives the appearance that the sensitive application is running locally on the client device. Consequently, after the sensitive application is closed in the desktop 202 and/or after it is popped-out of the desktop 202, establishing of the collaborative session can proceed.

If the primary user chooses to stop sharing the desktop 202 when they are prompted with the warning dialog, then sharing of the desktop with collaborators can be stopped (e.g., GUI frame updates will not be sent to secondary users) until the sensitive application is closed by the primary user in the desktop 202.

If the primary user chooses to continue sharing the desktop 202 when they are prompted with the warning dialog, the collaboration session can be continued without hiding the sensitive application. The content of the sensitive application may then be shared with the secondary sessions.

After invited collaborators are authenticated and a collaborative session is established, the primary user and secondary users can begin to collaboratively access the desktop 202. The desktop 202 can be shared with each collaborator (e.g., the GUI 203 can be sent to each collaborator's client 231, 232, 233) as described previously. If, while the collaborative session is running, a sensitive application (e.g., an application identified in the list 240) opens in the virtual desktop 202, the desktop sharing can be stopped (e.g., the system can stop sending the GUI 203 (e.g., GUI frame updates) to the collaborator clients 231, 232, 233) and a similar warning as described above can be produced for the primary user to notify them that a sensitive application is open. Also, as above in the case where a sensitive application is open before the collaborative session is initiated, the primary user can be provided with options on how to proceed regarding the open sensitive application. For example, a warning dialog can pop up notifying the user that a sensitive application is open and the user can be provided with several choices in the dialog on how to treat the sensitive application. The choices can be to minimize the application, close the application, pup-out the sensitive application from the remote desktop, stop sharing the desktop, or continue sharing the desktop (without hiding the application).

For example, if an application, Application A (e.g., an email client), which is identified in the sensitive application list 240, is opened in the desktop 202 during the collaborative session, desktop sharing can be stopped and a warning popup dialog can be presented to the user with the message “Application A is open, do you wish to hide it from collaborators?”. The user can be allowed to select any of various options in the dialog on how to proceed as described above (close the application, minimize the application, pop-out the application, stop desktop sharing, or continue desktop sharing). The desktop sharing can be paused until the primary user makes their selection and the selection is carried out.

For example, during the collaborative session, the user can receive an email or instant message causing an email client application on the sensitive app list 240 or an instant message application on the instant app list 240 to open, or the primary user may make an action opening a sensitive application themselves. Desktop sharing can then be paused until the user selects how they wish to proceed in the warning dialog prompt and the selection is carried out.

If the primary user chooses to minimize the application when they are prompted with the warning dialog, the sensitive application window can be minimized before resuming sharing the desktop 202 (e.g., before resuming sending the GUI 203 to collaborator clients 231, 232, 233).

If the primary user chooses to close the application when they are prompted with the warning dialog, the sensitive application can be closed before resuming sharing the desktop 202 (e.g., before resuming sending the GUI 203 to collaborator clients 231, 232, 233).

If the primary user chooses to pop-out the sensitive application from the remote desktop 202 when they are prompted with the warning dialog, the sensitive application can be closed in the desktop 202 and popped out in a separate window on the client device 210, as described above. After the sensitive application is closed in the desktop 202 and/or after it is popped-out of the desktop 202, sharing of the desktop 202 can be resumed (e.g., sending the GUI 203 to collaborator clients 231, 232, 233 can resume).

If the primary user chooses to stop sharing the desktop 202 when they are prompted with the warning dialog, then the desktop sharing can be stopped (e.g., GUI frame updates will stop being sent to secondary users) until the sensitive application is closed by the primary user.

If the primary user chooses to continue sharing the desktop 202 when they are prompted with the warning dialog, the collaboration session can be resumed without hiding the sensitive application and the content from the sensitive application may be shared with the secondary sessions.

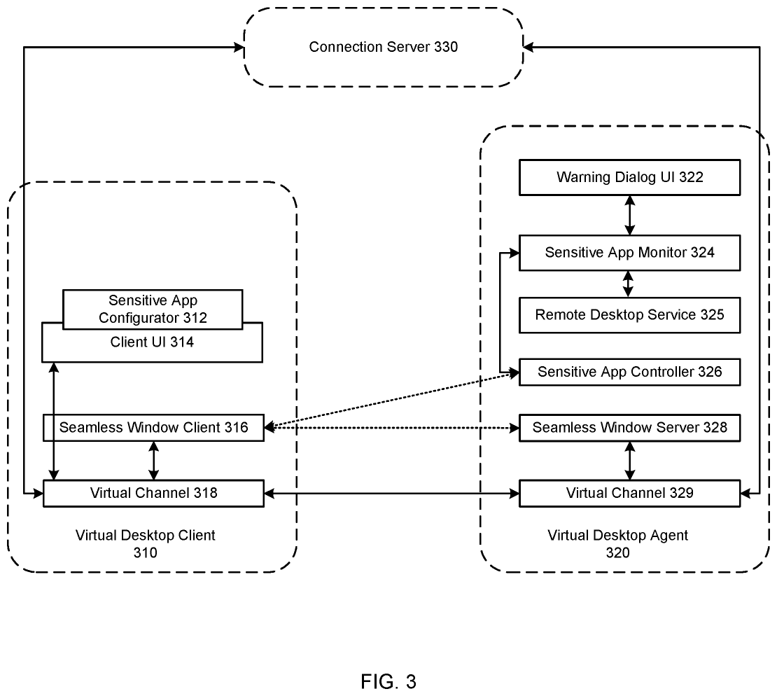

FIG. 3 illustrates an example of components in a system for hiding sensitive information in collaborative virtual desktop sessions, in accordance with various embodiments. The example of FIG. 3 illustrates a client 310, which can be a virtual desktop client installed on a local client device (such as the client 220 in the example of FIG. 2) used by a primary user to access their virtual desktop (such as the desktop 202 in the example of FIG. 2), on which a virtual desktop agent 320 operates (such as the agent 212 in the example of FIG. 2).

The example of FIG. 3 further illustrates a connection server 330, which can be configured to perform functions such as brokering client connections to virtual desktops, managing virtual desktop sessions, authenticating users, etc. The connection server 330 can facilitate establishing the virtual desktop session for the client 310 and connecting the client 310 with the virtual desktop agent 320 operating in the virtual desktop. For example, when the user requests the client 310 to connect to the remote desktop, the client 310 can send a request to the connection server 330 to connect to the desktop and the connection server 330 can facilitate establishing the connection. Similarly, when the user invites collaborators to establish a collaborative session, the connection server 330 can authenticate the secondary users, facilitate establishing the connections between each collaborator's virtual desktop client and the desktop, and manage the secondary sessions on the virtual desktop for the secondary users.

After the primary user establishes the remote desktop session, a remote desktop service 325 operating on the agent 320 can begin sending the GUI (or the GUI frame updates) of the virtual desktop to the client 310. The remote desktop service 325 can operate under a remote display protocol. When a collaborative session with other clients is established, the remote desktop service 325 can send the GUI of the virtual desktop to each of the collaborators' virtual desktop clients to share the desktop with the collaborators.

As illustrated, the virtual desktop client 310 can contain a sensitive application configurator component 312. When the client 310 connects to the connection server 330, the sensitive application configurator 312 can obtain the list of sensitive applications on the client 310 and send the list of sensitive applications to the connection server 330. The connection server 330 can then forward the list to the virtual desktop agent 320, which can store the list in the remote desktop.

As described earlier, the user may be able to designate or select the sensitive applications in the client UI 314 (e.g., in settings). The sensitive application configurator component 312 can retrieve the applications designated as sensitive by the user from the settings via the client UI 314 and send a list identifying the sensitive applications to the connection server 330.

The agent 320 can contain a warning dialog user interface (UI) component 322. This component can be responsible for producing a dialog popup warning the user and giving the user options of how to proceed when a predesignated sensitive application is open during a collaborative session, or when the primary user initiates a collaborative session. For example, when the primary user attempts to initiate a collaborative session and invite a collaborator, if a designated sensitive application (contained in the supplied list from the client 310) is detected on the agent 320 side, the warning dialog UI component 322 can pop up a warning dialog to warn the primary user and give them options, as described previously.

Similarly, if during a collaborative session a newly opened sensitive application is detected, the warning dialog UI component 322 can pop up a warning dialog to warn the primary user and give them options, as also described previously.

The agent 320 can further contain a sensitive application monitor component 324, which can be responsible for monitoring sensitive applications and detecting when a sensitive application is opened in the virtual desktop. For example, the sensitive application monitor 324 can communicate with the operating system (OS) of the virtual desktop to determine what applications are running, or the OS can notify the sensitive application monitor 324 when a sensitive application is launched.

When the sensitive application monitor 324 detects that a sensitive application is launched, it can notify the remote desktop service 325 to stop or pause sharing the desktop with any collaborators (e.g., to stop sending GUI updates). The sensitive application monitor 324 can then instruct the warning dialog UI module 322 to pop up a warning dialog warning the primary user that a sensitive application is open and requesting the primary user to make a choice of how to proceed or treat the sensitive application, as described previously. At the same time, the sensitive application monitor 324 can notify a sensitive application controller module 326 on the agent 320 to handle the sensitive application according to the choice that the primary user has made in the warning dialog. After the sensitive application is handled accordingly, the remote desktop service 325 can resume sending virtual desktop GUI frame updates to the collaborator clients (e.g., the sensitive app monitor 324 can instruct the remote desktop service 325 to resume sending the GUI).

The sensitive application controller component 326 can be responsible for processing the events passed to it by the sensitive application monitor module 324. The sensitive application monitor module 324 can pass the user selection received from the warning dialog UI 322 to the sensitive application controller 326, and the sensitive application controller 326 can process the event according to the user selection. For example, if the user chooses to minimize or close the sensitive application, the sensitive application controller 326 can minimize or close the sensitive application, accordingly.

If the user chooses to pop out the seamless application, the sensitive application controller 326 can carry out the process for popping out the application. For example, the sensitive application controller 326 can send a request to the client 310 to launch the sensitive application as a seamless window (or as a virtual application). The sensitive application controller 326 can include any required information in the request, such as the sensitive application name, the application location, the application icon, etc. The client 310 can communicate with a seamless window server 328 on the remote desktop to perform the operation. For example, the sensitive application can be launched on a second remote desktop and be remoted to the primary user's client device (e.g., it can be displayed in a second window of the client 310, other than the window where the primary user's virtual desktop GUI is displayed). Any data or needed information for launching the application in the second remote desktop can be provided by the agent 320, for example via the seamless window sever 328. The user can then interact with the sensitive application that is running remotely as if it was running locally on the primary user's client device. Other portions of the guest desktop where the sensitive application runs can be hidden or obscured, so that only the application's window is remoted. When collaboration session ends, the sensitive application controller 326 can request the client 310 to the close seamless window and launch the sensitive application in the remote desktop again.

In various embodiments, a virtual channel (e.g., protocol virtual channel) can be implemented for data transfer between the client 310 and the remote desktop. As illustrated, the client 310 in the client device can contain a virtual channel module 318 that can manage communications over a virtual channel established with a corresponding virtual channel module 329 in the virtual desktop agent 320. During a collaborative session, similar virtual channels for data transfer can be established between the virtual desktop and each collaborator client.

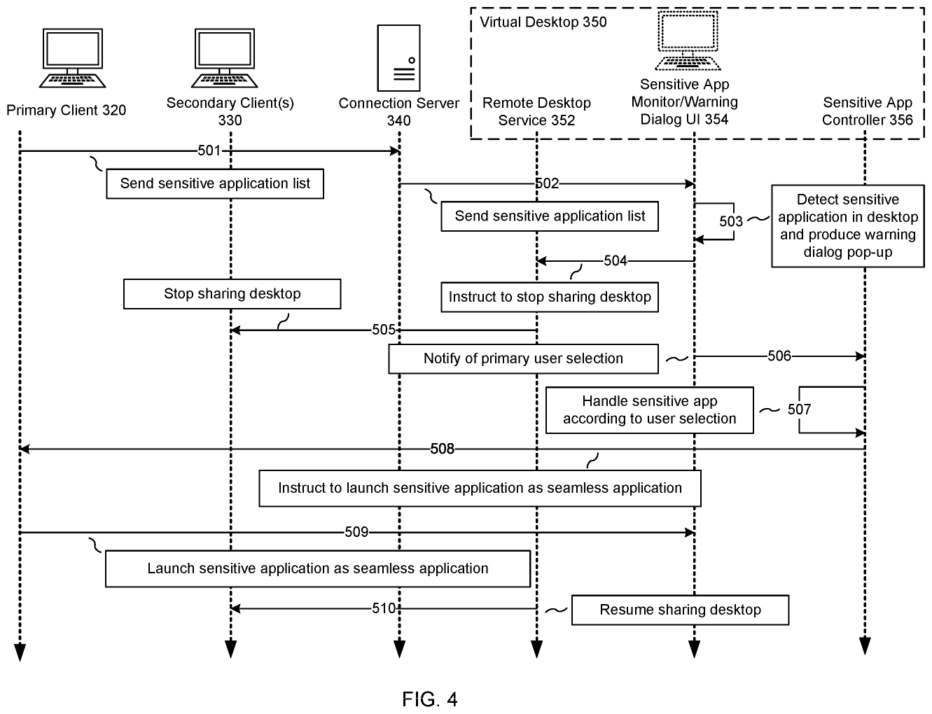

FIG. 4 illustrates an example swim lane diagram of a process for hiding sensitive information in collaborative virtual desktop sessions, in accordance with various embodiments. The illustrated process can take place in a system for providing collaborative access to a virtual desktop 350 by a primary client 320, which can be a virtual desktop client used by a primary user who owns the desktop 350, and one or more secondary clients 330, which can be virtual desktop clients used by secondary users or collaborators who are invited by the primary user to collaborate on the virtual desktop 350, as described above.

In operation 501, the primary client 320 can retrieve a list of sensitive applications on the client 320 and send it to a connection server 340. The connection server 340 can receive the sensitive application list and send it to the virtual desktop 350, where the sensitive application monitor module 354 can access the sensitive application list to monitor when sensitive applications are opened in the desktop 350.

In operation 503, the sensitive application monitor 354 can detect that a sensitive application is opened in the desktop and the sensitive application monitor 354 can further instruct the warning dialog UI module to produce a warning dialog pop-up informing the user that a sensitive application is open in the desktop 350 and requesting the user to select an option on how to proceed (whether to minimize, close, pop-out the app, etc.), as described above. In operation 504, the sensitive application monitor 354 can instruct the remote desktop service 352 to stop sharing the desktop with the secondary client(s) 330. The remote desktop service 352 can then stop sharing the desktop (e.g., stop sending GUI frame updates) to the secondary client(s) 330 in operation 505.

After the primary user makes a selection in the warning dialog UI, in operation 506, the sensitive application monitor 354 can notify the sensitive application controller 356 running in the desktop 350 of the primary user's selection. In operation 507, the sensitive application controller 356 can handle the sensitive application according to the primary user's selection. For example, if the primary user selected to minimize the application, then the sensitive application controller 356 can minimize the application; if the primary user selected to close the application, then the sensitive application controller 356 can close the application in the desktop 350; etc.

If the primary user selects to pop-out the application, then the sensitive application controller 356 can close the application in the desktop 350 and, in operation 508, it can instruct the primary client 320 to launch the sensitive application as a seamless application (as a seamless window), as described above. In operation 509, the primary client 320 can launch the sensitive application as a seamless application that is popped out of the desktop 350 (e.g., as a virtual application). In operation 510, the remote desktop service 352 can resume sharing the desktop with the secondary client(s) 330.

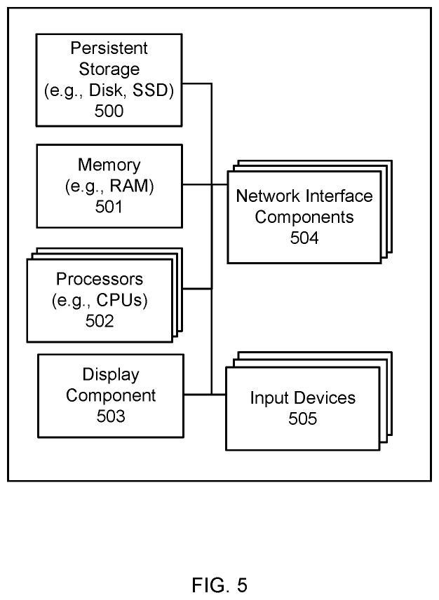

FIG. 5 illustrates an example of some general components of a computing device, in accordance with various embodiments. In this particular example, the device includes one or more processors (e.g., central processing units (CPUs) 502 for executing instructions that can be stored in a storage medium component. The storage medium can include many types of memory, persistent data storage, or non-transitory computer-readable storage media. For example, the storage medium may take the form of random access memory (RAM) 501 storing program instructions for execution by the processor(s) 502, a persistent storage (e.g., disk or SSD) 500, a removable memory for sharing information with other devices and/or the like. The computing device typically can further comprise a display component 503, such as a monitor, a touch screen, liquid crystal display (LCD), or the like. In various embodiments, the computing device will include at least one input device 505 able to receive conventional input from a user. This conventional input can include, for example, a push button, touch pad, touch screen, wheel, joystick, keyboard, mouse, keypad, or any other such device or element whereby a user can input a command to the device. In some embodiments, the computing device can include a network interface component (NIC) 504 for communicating over various networks, such as a Wi-Fi®, Bluetooth®, RF, wired, or wireless communication systems. The device in many embodiments can communicate over a network, such as the Internet, and may be able to communicate with other devices connected to the same or other network.

Various embodiments described herein can be implemented in a wide variety of environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Many embodiments utilize at least one network that would be familiar to those skilled in the art for supporting communications using any of a variety of commercially-available protocols, such as TCP/IP, FTP, UDP or the like. The network can be, for example, a local area network, a wide-area network, a virtual private network, the Internet, an intranet, an extranet, a public switched telephone network, an infrared network, a wireless network, and any combination thereof.

The various environments in which the embodiments can be implemented may include a variety of data stores and other memory and storage media, as discussed above. These can reside in a variety of locations, such as on a storage medium local to one or more of the computers or remote from any or all of the computers across the network. In some embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method, comprising:
establishing a collaborative session on a primary user's virtual desktop with one or more secondary users, wherein a graphical user interface (GUI) of the virtual desktop is streamed to a virtual desktop client running on a client device of the primary user and to a virtual desktop client running on a client device of each of the one or more secondary users;
detecting that a predesignated sensitive application is open in the virtual desktop; and
in response to detecting that the sensitive application is open in the virtual desktop, stopping streaming the GUI to the virtual desktop client of each of the one or more secondary users.

2. The method of claim 1, further comprising:
in response to detecting that the sensitive application is open in the virtual desktop, presenting a warning dialog in the virtual desktop with a warning message indicating that the sensitive application is open in the virtual desktop.

3. The method of claim 1, further comprising:
in response to detecting that the sensitive application is open in the virtual desktop, presenting a dialog in the virtual desktop that provides the primary user with one or more options for handling the open sensitive application, the options including one or more of:
to minimize the sensitive application;
to close the sensitive application;
to pop-out the sensitive application from the remote desktop in a separate window;
to stop sharing the virtual desktop with collaborators; or
to continue sharing the virtual desktop without taking action; and
handling the open sensitive application according to the primary user's selection in the dialog.

4. The method of claim 3, further comprising:
after handling the open sensitive application according to the primary user's selection in the dialog, resuming streaming the GUI to the virtual desktop client of each of the one or more secondary users.

5. The method of claim 1, further comprising:
popping-out the opened sensitive application from the remote desktop in a separate window by:
closing the opened sensitive application in the virtual desktop; and
launching the sensitive application as a virtual application in a new window on the primary user's client device.

6. The method of claim 1, further comprising, prior to establishing the collaborative session on the primary user's virtual desktop:
receiving a request from the primary user to invite the one or more secondary users into the collaborative session;
detecting that a predesignated sensitive application is open in the virtual desktop;
in response to detecting that the sensitive application is open in the virtual desktop, presenting a dialog in the virtual desktop that provides the primary user with one or more options for handling the open sensitive application, the options including one or more of:
to minimize the sensitive application;
to close the sensitive application;
to pop-out the sensitive application from the remote desktop in a separate window;
to stop sharing the virtual desktop with collaborators; or
to continue sharing the virtual desktop without taking action; and
handling the open sensitive application according to the primary user's selection in the dialog before streaming the GUI of the virtual desktop to the virtual desktop client of any of the one or more secondary users.

7. The method of claim 1, further comprising:
sending a list of predesignated sensitive applications by the virtual desktop client of the primary user to the virtual desktop; and
monitoring the virtual desktop to detect when an application in the list of predesignated sensitive applications is opened.

8. A computing device, comprising:
at least one processor; and
memory including instructions that, when executed by the at least one processor, cause the computing device to perform the steps of:
establishing a collaborative session on a primary user's virtual desktop with one or more secondary users, wherein a graphical user interface (GUI) of the virtual desktop is streamed to a virtual desktop client running on a client device of the primary user and to a virtual desktop client running on a client device of each of the one or more secondary users;
detecting that a predesignated sensitive application is open in the virtual desktop; and
in response to detecting that the sensitive application is open in the virtual desktop, stopping streaming the GUI to the virtual desktop client of each of the one or more secondary users.

9. The computing device of claim 8, wherein the memory further includes instructions that when executed by the at least one processor, cause the computing device to perform the steps of:
in response to detecting that the sensitive application is open in the virtual desktop, presenting a warning dialog in the virtual desktop with a warning message indicating that the sensitive application is open in the virtual desktop.

10. The computing device of claim 8, wherein the memory further includes instructions that when executed by the at least one processor, cause the computing device to perform the steps of:
in response to detecting that the sensitive application is open in the virtual desktop, presenting a dialog in the virtual desktop that provides the primary user with one or more options for handling the open sensitive application, the options including one or more of:
to minimize the sensitive application;
to close the sensitive application;
to pop-out the sensitive application from the remote desktop in a separate window;
to stop sharing the virtual desktop with collaborators; or
to continue sharing the virtual desktop without taking action; and
handling the open sensitive application according to the primary user's selection in the dialog.

11. The computing device of claim 10, wherein the memory further includes instructions that when executed by the at least one processor, cause the computing device to perform the steps of:
after handling the open sensitive application according to the primary user's selection in the dialog, resuming streaming the GUI to the virtual desktop client of each of the one or more secondary users.

12. The computing device of claim 8, wherein the memory further includes instructions that when executed by the at least one processor, cause the computing device to perform the steps of:
popping-out the opened sensitive application from the remote desktop in a separate window by:
closing the opened sensitive application in the virtual desktop; and
launching the sensitive application as a virtual application in a new window on the primary user's client device.

13. The computing device of claim 8, wherein the memory further includes instructions that when executed by the at least one processor, cause the computing device to, prior to establishing the collaborative session on the primary user's virtual desktop, perform the steps of:
receiving a request from the primary user to invite the one or more secondary users into the collaborative session;
detecting that a predesignated sensitive application is open in the virtual desktop;
in response to detecting that the sensitive application is open in the virtual desktop, presenting a dialog in the virtual desktop that provides the primary user with one or more options for handling the open sensitive application, the options including one or more of:
to minimize the sensitive application;
to close the sensitive application;
to pop-out the sensitive application from the remote desktop in a separate window;
to stop sharing the virtual desktop with collaborators; or
to continue sharing the virtual desktop without taking action; and
handling the open sensitive application according to the primary user's selection in the dialog before streaming the GUI of the virtual desktop to the virtual desktop client of any of the one or more secondary users.

14. The computing device of claim 8, wherein the memory further includes instructions that when executed by the at least one processor, cause the computing device to perform the steps of:
sending a list of predesignated sensitive applications by the virtual desktop client of the primary user to the virtual desktop; and
monitoring the virtual desktop to detect when an application in the list of predesignated sensitive applications is opened.

15. A non-transitory computer readable storage medium comprising one or more sequences of instructions, the instructions when executed by one or more processors causing the one or more processors to execute the operations of:
establishing a collaborative session on a primary user's virtual desktop with one or more secondary users, wherein a graphical user interface (GUI) of the virtual desktop is streamed to a virtual desktop client running on a client device of the primary user and to a virtual desktop client running on a client device of each of the one or more secondary users;
detecting that a predesignated sensitive application is open in the virtual desktop; and
in response to detecting that the sensitive application is open in the virtual desktop, stopping streaming the GUI to the virtual desktop client of each of the one or more secondary users.

16. The non-transitory computer readable storage medium of claim 15, further comprising instructions that when executed by the one or more processors cause the one or more processors to execute the operations of:
in response to detecting that the sensitive application is open in the virtual desktop, presenting a warning dialog in the virtual desktop with a warning message indicating that the sensitive application is open in the virtual desktop.

17. The non-transitory computer readable storage medium of claim 15, further comprising instructions that when executed by the one or more processors cause the one or more processors to execute the operations of:
in response to detecting that the sensitive application is open in the virtual desktop, presenting a dialog in the virtual desktop that provides the primary user with one or more options for handling the open sensitive application, the options including one or more of:
to minimize the sensitive application;
to close the sensitive application;
to pop-out the sensitive application from the remote desktop in a separate window;
to stop sharing the virtual desktop with collaborators; or
to continue sharing the virtual desktop without taking action; and
handling the open sensitive application according to the primary user's selection in the dialog.

18. The non-transitory computer readable storage medium of claim 17, further comprising instructions that when executed by the one or more processors cause the one or more processors to execute the operations of:
after handling the open sensitive application according to the primary user's selection in the dialog, resuming streaming the GUI to the virtual desktop client of each of the one or more secondary users.

19. The non-transitory computer readable storage medium of claim 15, further comprising instructions that when executed by the one or more processors cause the one or more processors to execute the operations of:
popping-out the opened sensitive application from the remote desktop in a separate window by:
closing the opened sensitive application in the virtual desktop; and
launching the sensitive application as a virtual application in a new window on the primary user's client device.

20. The non-transitory computer readable storage medium of claim 15, further comprising instructions that when executed by the one or more processors cause the one or more processors to, prior to establishing the collaborative session on the primary user's virtual desktop, execute the operations of:
receiving a request from the primary user to invite the one or more secondary users into the collaborative session;
detecting that a predesignated sensitive application is open in the virtual desktop;
in response to detecting that the sensitive application is open in the virtual desktop, presenting a dialog in the virtual desktop that provides the primary user with one or more options for handling the open sensitive application, the options including one or more of:
to minimize the sensitive application;
to close the sensitive application;
to pop-out the sensitive application from the remote desktop in a separate window;
to stop sharing the virtual desktop with collaborators; or
to continue sharing the virtual desktop without taking action; and
handling the open sensitive application according to the primary user's selection in the dialog before streaming the GUI of the virtual desktop to the virtual desktop client of any of the one or more secondary users.
